(19) United States
(12) Patent Application Publication
(10) Pub. No.: US 2013/0121027 A1
(43) Pub. Date: May 16, 2013

(54) LIGHT SOURCE DEVICE, DISPLAY DEVICE, AND ELECTRONIC APPARATUS

(71) Applicant: Sony Corporation, Tokyo (JP)

(72) Inventor: Masaru Minami, Kanagawa (JP)

(73) Assignee: Sony Corporation, Tokyo (JP)

(21) Appl. No.: 13/667,716

(22) Filed: Nov. 2, 2012

(30) Foreign Application Priority Data
Nov. 10, 2011 (JP) 2011-246773

(51) Int. Cl. F21V 8/00

(52) U.S. Cl. 362/613

(57) ABSTRACT

A light source device includes: a first light source emitting first illumination light; a light guide plate including a plurality of scattering areas each allowing the first illumination light that has entered the light guide plate through a side surface thereof to be scattered and to exit therethrough; a second light source disposed to face the light guide plate, and emitting second illumination light toward the light guide plate from a direction different from a light emitting direction of the first light source; and light shields arranged between the light guide plate and the second light source at positions other than positions corresponding to the plurality of scattering areas, each of the light shields blocking the second illumination light.

### BACKGROUND

The present disclosure relates to a light source device, a display device, and an electronic apparatus that allow stereoscopic viewing by a parallax barrier system.

A stereoscopic display device that adopts the parallax barrier system is known as one of stereoscopic display systems that allow naked stereoscopic viewing with no specific spectacles. Such stereoscopic display device is of the type that a parallax barrier is arranged in opposition to a front surface (on the side of a display surface) of a two-dimensional display panel. The parallax barrier is generally structured such that light shielding parts that block display image light from a two-dimensional display panel and striped openings (slit parts) through which the display image light is transmitted are alternately disposed horizontally.

In the parallax barrier system, parallactic images (a right-eye perspective image and a left-eye perspective image in case of two perspectives) for stereoscopic viewing are space-divided and displayed on the two-dimensional display panel and the parallactic images are mutually separated horizontally by the parallax barrier to attain stereoscopic viewing. When a viewer looks a stereoscopic display device from predetermined position and direction, it is allowed to make light rays of different parallactic images separately incident upon the right and left eyes of the viewer via the slit parts by appropriately setting the width of each slit in the parallax barrier.

It is to be noted that when, for example, a transmission type liquid crystal display panel is used as the two-dimensional display panel, a configuration in which the parallax barrier is arranged on the side of a rear surface of the two-dimensional display panel is also allowed (see, for example, FIG. 10 of Japanese Patent No. 3565391 and FIG. 3 of Japanese Unexamined Patent Application Publication No. 2007-187823). In the above mentioned case, the parallax barrier is arranged between the transmission type liquid crystal display panel and a backlight.

### SUMMARY

However, a stereoscopic display device of the parallax barrier system as mentioned above uses a component dedicated to three-dimensional display, i.e., the parallax barrier, and hence has such a disadvantage that a larger number of components and a wider arrangement space than those in a typical display device for two-dimensional display are used. In addition, a display device configured to optionally switch display between two-dimensional display and three-dimensional display is in demand. In the above mentioned case, it is desirable that display be favorably performed both in two-dimensional display and three-dimensional display. For this purpose, it is desirable that illumination light which exhibits an appropriate luminance distribution be obtained both in the two-dimensional display and the three-dimensional display.

It is desirable to provide a light source device, a display device, and an electronic apparatus that implement a function which is equivalent to a parallax barrier by using a light guide plate and allow acquisition of illumination light which exhibits the appropriate luminance distribution.

A light source device according to an embodiment of the present disclosure includes: a first light source emitting first illumination light; a light guide plate including a plurality of scattering areas each allowing the first illumination light that has entered the light guide plate through a side surface thereof to be scattered and to exit therethrough; a second light source disposed to face the light guide plate, and emitting second illumination light toward the light guide plate from a direction different from a light emitting direction of the first light source; and light shields arranged between the light guide plate and the second light source at positions other than positions corresponding to the plurality of scattering areas, each of the light shields blocking the second illumination light.

A display device according to an embodiment of the present disclosure includes: a display section displaying an image; and a light source unit emitting light for image display toward the display section. The light source unit includes a first light source emitting first illumination light, a light guide plate including a plurality of scattering areas each allowing the first illumination light that has entered the light guide plate through a side surface thereof to be scattered and to exit therethrough, a second light source disposed to face the light guide plate, and emitting second illumination light toward the light guide plate from a direction different from a light emitting direction of the first light source, and light shields arranged between the light guide plate and the second light source at positions other than positions corresponding to the plurality of scattering areas, each of the light shields blocking the second illumination light.

An electronic apparatus according to an embodiment of the present disclosure is provided with a display device. The display device includes: a display section displaying an image; and a light source unit emitting light for image display toward the display section. The light source unit includes a first light source emitting first illumination light, a light guide plate including a plurality of scattering areas each allowing the first illumination light that has entered the light guide plate through a side surface thereof to be scattered and to exit therethrough, a second light source disposed to face the light guide plate, and emitting second illumination light toward the light guide plate from a direction different from a light emitting direction of the first light source, and light shields arranged between the light guide plate and the second light source at positions other than positions corresponding to the plurality of scattering areas, each of the light shields blocking the second illumination light.

In the light source device, the display device, and the electronic apparatus according to the above-described respective embodiments of the present disclosure, the first illumination light from the first light source is scattered through the scattering areas and exits outside of the light guide plate. Thus, it is allowed to make the light guide plate itself function as a parallax barrier for the first illumination light. That is, it is allowed to make it function equivalently as the parallax barrier by using the scattering area as an opening (a slit part) in the parallax barrier. Thus, it is allowed to cope with three-dimensional display. In addition, it is also allowed to cope with two-dimensional display by emitting the second illumination light from the direction different from the light emitting direction of the first light source toward the light guide plate. In the above mentioned case, since the light shields are arranged between the light guide plate and the second light source at the positions other than the positions corresponding to the plurality of scattering areas, a luminance distribution in the two-dimensional display is improved.

According to the light source device, the display device, and the electronic apparatus of the above-described respective embodiments of the present disclosure, since the plurality of scattering areas that allow the first illumination light to be scattered are provided in and/or on the light guide plate, it is allowed to make the light guide plate itself equivalently function as the parallax barrier for the first illumination light. In addition, since the light shields are arranged between the light guide plate and the second light source at the positions other than the positions corresponding to the plurality of scattering areas, it is allowed to improve the luminance distribution exhibited when the second illumination light has been emitted. Thus, it is allowed to obtain the illumination light that exhibits the appropriate luminance distribution.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a sectional diagram illustrating one configuration example of a display device according to a first embodiment of the present disclosure, together with an example of a state that light rays exit from a light source unit when only a first light source has been set to an ON (turned-on) state.

FIG. 2A is a sectional diagram illustrating one configuration example of the display device illustrated in FIG. 1, together with an example of a state that light rays exit from the light source unit when only a second light source has been set to the ON (turned-on) state, and FIG. 2B is a diagram illustrating an example of a luminance distribution obtained when only the second light source has been set the ON state.

FIG. 3 is a plan view illustrating one example of an arrangement pattern of scattering areas and light shielding parts in the display device illustrated in FIG. 1.

FIG. 4 is a plan view illustrating one example of a pixel structure on a display section.

FIG. 5A is a sectional diagram illustrating a first configuration example of a surface of a light guide plate in the display device illustrated in FIG. 1, and FIG. 5B is a diagram schematically illustrating an example of a state that light rays are scattered and reflected on the surface of the light guide plate illustrated in FIG. 5A.

FIG. 6A is a sectional diagram illustrating a second configuration example of the surface of the light guide plate in the display device illustrated in FIG. 1, and FIG. 6B is a diagram schematically illustrating an example of a state that the light rays are scattered and reflected on the surface of the light guide plate illustrated in FIG. 6A.

FIG. 7A is a sectional diagram illustrating a third configuration example of the surface of the light guide plate in the display device illustrated in FIG. 1, and FIG. 7B is a diagram schematically illustrating an example of a state that light rays are scattered and reflected on the surface of the light guide plate illustrated in FIG. 7A.

FIG. 8 is a sectional diagram illustrating one configuration example of a display device according to a comparative example, together with an example of a state that light rays exit from a light source unit when only a first light source has been set to the ON (turned-on) state.

FIG. 9 is a sectional diagram illustrating one configuration example of the display device according to the comparative example, together with an example of an ideal state that light rays exit from the light source unit when only a second light source has been set to the ON (turned-on) state.

FIG. 10A is a sectional diagram illustrating one configuration example of the display device according to the comparative example, together with an example of a state that light rays exit from the light source unit when only the second light source has been set to the ON (turned-on) state, and FIG. 10B is a diagram illustrating an example of a luminance distribution obtained when only the second light source has been set to the ON state.

FIG. 11 is a sectional diagram illustrating one configuration example of a display device according to a first modification example.

FIG. 12 is a sectional diagram illustrating one configuration example of a display device according to a second modification example.

FIG. 13 is a plan view illustrating one example of an arrangement pattern of scattering areas and light shielding parts of the display device according to the second modification example.

FIG. 14 is a sectional diagram illustrating one configuration example of a display device according to a third modification example.

FIG. 15 is a plan view illustrating one example of an arrangement pattern of scattering areas and light shielding parts of a display device according to a fourth modification example.

FIG. 16 is a sectional diagram illustrating one configuration example of a display device according to a fifth modification example.

FIG. 17 is a sectional diagram illustrating one configuration example of a display device according to a sixth modification example.

FIG. 18 is a sectional diagram illustrating one configuration example of a display device according to a seventh modification example.

FIG. 19 is an outside view illustrating one example of an electronic apparatus.

### DETAILED DESCRIPTION

Next, preferred embodiments of the present disclosure will be described in detail with reference to the accompanying drawings. It is to be noted that description will be made in the following order.
1. First Embodiment

Configuration example of a display device in which a light shielding part is arranged on a surface of a light guide plate which is in opposition to a second light source
2. Second Embodiment

First to seventh modification examples
3. Other Embodiments

Configuration example of electronic apparatus, etc.

### 1. First Embodiment

### [General Configuration of Display Device]

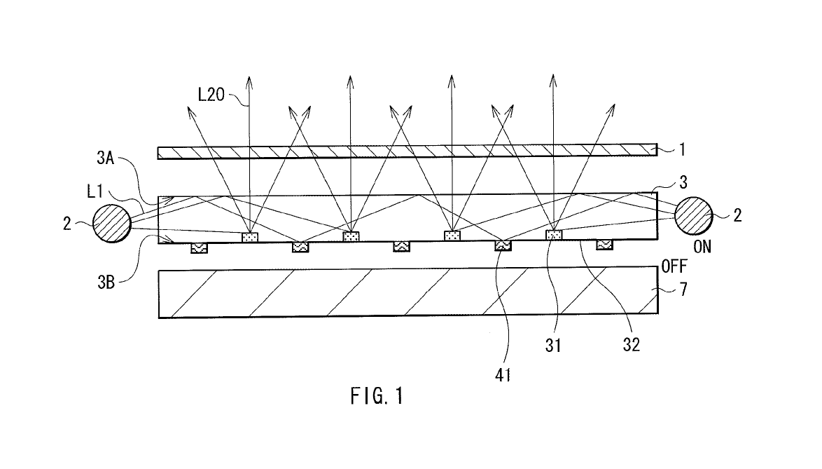

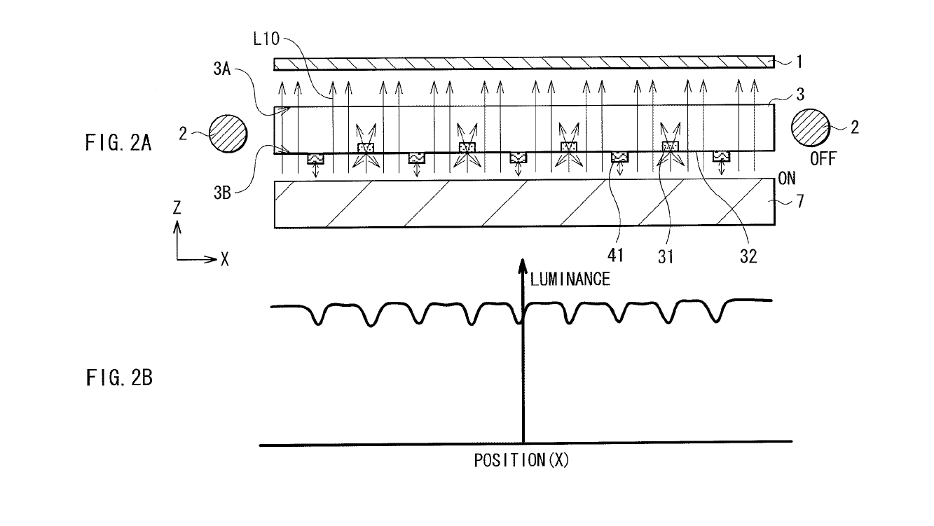

FIG. 1 and FIG. 2A illustrate one configuration example of a display device according to a first embodiment of the present disclosure. The display device includes a display section 1 that displays an image, and a light source unit which is arranged on the rear surface side of the display section 1 to emit light for image display toward the display section 1. The light source unit includes a first light source 2 (a light source for 2D/3D display), a light guide plate 3, and a second light source 7 (a light source for 2D display). The light source unit also includes a light shielding part (light shield) 41 which is arranged between the light guide plate 3 and the second light source 7. The light guide plate 3 includes a first internally reflecting surface 3A which is disposed on one side in opposition to the display section 1 and a second internally reflecting surface 3B which is disposed on the other side in opposition to the second light source 7. It is to be noted that although the display device also includes a control circuit or the like for the display section 1 which is used for display in addition to the above elements, since the configuration thereof is the same as that of a general control circuit or the like for display, description thereof will be omitted. In addition, though not illustrated in the drawings, the light source unit also includes a control circuit that controls ON (turned-on) and OFF (not turned-on) states of the first light source 2 and the second light source 7.

It is to be noted that in the first embodiment a first in-plane direction (a vertical direction) which is in parallel with a display surface (a surface on which pixels are arrayed) of the display section 1 or the second internally reflecting surface 3B of the light guide plate 3 will be referred to as a Y direction, a second direction (a horizontal direction) orthogonal to the first direction will be referred to as an X direction, and a direction (a thickness direction) orthogonal to the Y direction and the X direction will be referred to as a Z direction.

The display device is allowed to optionally and selectively perform mode-switching between a mode in which two-dimensional (2D) display is performed on the entire screen and a mode in which three-dimensional (3D) display is performed on the entire screen. Switching between the two-dimensional display mode and the three-dimensional display mode is allowed by performing switching control of image data to be displayed on the display section 1 and performing switching control of the ON and OFF states of the first light source 2 and the second light source 7. Although FIG. 1 schematically illustrates an example of a state that light rays exit from the light source unit when only the first light source 2 has been set to the ON (turned-on) state, this state corresponds to the three-dimensional display mode. Although FIG. 2A schematically illustrates an example of a state that light rays exit from the light source unit when only the second light source 7 has been set to the ON (turned-on) state, this state corresponds to the two-dimensional display mode.

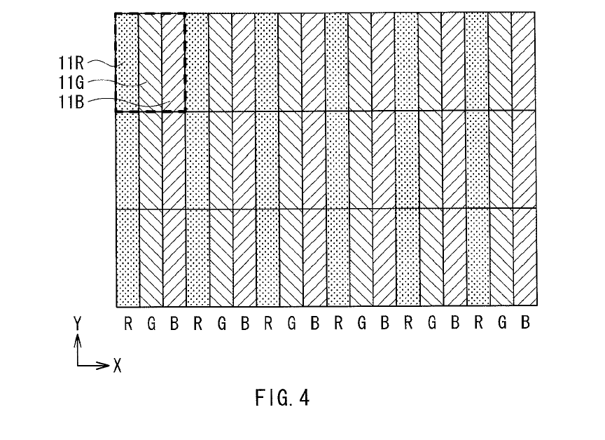

The display section 1 is configured by a transmission type two-dimensional display panel such as, for example, a transmission type liquid crystal display panel, and includes a plurality of pixels that includes pixels for R (red) 11R, pixels for G (green) 11G, and pixels for B (blue) 11B, for example, as illustrated in FIG. 4. The plurality of pixels are arranged in a matrix. The display section 1 performs two-dimensional image display by modulating light from the light source unit in accordance with image data in units of pixels of respective colors. A plurality of perspective images which are based on three-dimensional image data and an image which is based on two-dimensional image data are optionally and selectively switched and displayed on the display section 1. It is to be noted that the three-dimensional image data is data that includes, for example, a plurality of perspective images corresponding to a plurality of viewing angle directions in three-dimensional display. For example, when binocular three-dimensional display is to be performed, it is data on perspective images for right-eye display and left-eye display. When display is to be performed in the three-dimensional display mode, for example, a composite image that includes a plurality of striped perspective images is generated and displayed in one screen.

The first light source 2 is configured by a fluorescent lamp such as, for example, a CCFL (Cold Cathode Fluorescent Lamp) or the like, or an LED (Light Emitting Diode). The first light source 2 emits first illumination light L1 (FIG. 1) from a side surface direction toward the inside of the light guide plate 3. One or more first light sources 2 are arranged on side surfaces of the light guide plate 3. For example, when the light guide plate 3 is square in plane, four side surfaces are present. However, it is good enough for the first light source(s) 2 to be arranged on at least any one of the four side surfaces. FIG. 1 illustrates a configuration example in which each first light source 2 is arranged on each of mutually opposing two side surfaces of the light guide plate 3. The first light source 2 is ON (turned-on)/OFF (not turned-on) controlled in accordance with switching between the two-dimensional display mode and the three-dimensional display mode. Specifically, the first light source 2 is controlled to enter the turned-on state when an image which is based on the three-dimensional image data is to be displayed on the display section 1 (in the three-dimensional display mode) and is controlled to enter the not turned-on state or the turned-on state when an image which is based on the two-dimensional image data is to be displayed on the display section 1 (in the two-dimensional display mode).

The second light source 7 is arranged in opposition to one side of the light guide plate 3 with the second internally reflecting surface 3B formed. The second light source 7 emits second illumination light L10 toward the light guide plate 3 from a direction which is different from the light emitting direction of the first light source 2. More specifically, the second light source 7 emits the second illumination light L10 from the outer side (the rear surface side of the light guide plate 3) toward the second internally reflecting surface 3B (see FIG. 2A). The second light source 7 may be a surface light source that emits light of uniform in-plane luminance and its structure itself is not limited to specific one, and a commercially-available surface backlight may be used. For example, the second light source 7 may employ a structure such as that in which an emitter such as, for example, the CCFL, the LED, or the like and a light diffuser that makes the in-plane luminance uniform are used. The second light source 7 is ON (turned-on)/OFF (not turned-on) controlled in accordance with switching between the two-dimensional display mode and the three-dimensional display mode. Specifically, the second light source 7 is controlled to enter the not turned-on state when an image which is based on the three-dimensional image data is to be displayed on the display section 1 (in the three-dimensional display mode) and is controlled to enter the turned-on state when an image which is based on the two-dimensional image data is to be displayed on the display section 1 (in the two-dimensional display mode).

The light guide plate 3 is configured by a transparent plastic sheet made of, for example, acrylic resin or the like. The light guide plate 3 is made transparent over the entire surfaces other than the second internally reflecting surface 3B. For example, when the light guide plate 3 is square in plane, the first internally reflecting surface 3A and four side surfaces thereof are made transparent over the entire surfaces.

The first internally reflecting surface 3A is mirror-finished over the entire surface, and totally internally reflects a light ray which has been incident at an angle of incidence that meets conditions for total reflection in the light guide plate 3, and makes a light ray that has failed to meet the conditions for total reflection exit outside.

The second internally reflecting surface 3B includes a scattering area 31 and a totally reflecting area 32. The scattering area 31 may be formed, for example, by performing laser beam machining, sand blasting, or coating on a surface of the light guide plate 3, or by applying a sheet-shaped light scattering member on the surface as describer later. On the second internally reflecting surface 3b, the scattering area 31 functions as an opening (a slit part) in a parallax barrier and the totally reflecting area 32 functions as a shielding part on the parallax barrier for the first illumination light L1 emitted from the first light source 2 in the three-dimensional display mode. On the second internally reflecting surface 3B, the scattering areas 31 and the totally reflecting areas 32 are arranged in patterns that have a structure corresponding to that of the parallax barrier. That is, the totally reflecting areas 32 are arranged in a pattern corresponding to that of the shielding parts on the parallax barrier and the scattering areas 31 are arranged in a pattern corresponding to that of the openings in the parallax barrier. It is to be noted that as a barrier pattern of the parallax barrier, various types of patterns such as, for example, a striped pattern in which many elongated-slit-shaped openings are arranged side-by-side horizontally with the shielding parts interposed between them may be used, and it is not limited to a specific pattern.

The first internally reflecting surface 3A and the totally reflecting area 32 on the second internally reflecting surface 3B totally internally reflect a light ray which has been incident at an angle of incidence θ1 that meets the conditions for total reflection (totally internally reflect the light ray which has been incident at the angle of incidence θl which is larger than a predetermined critical angle α). Thus, the first illumination light L1 which has been incident at the angle of incidence θ1 that meets the conditions for total reflection from the first light source 2 is totally internally reflected and guided in a side surface direction between the first internally reflecting surface 3A and the totally reflecting area 32 on the second internally reflecting surface 3B. In addition, the totally reflecting area 32 makes the second illumination light L10 from the second light source 7 transmit therethrough and exit as light rays that have failed to meet the conditions for total reflection toward the first internally reflecting surface 3A as illustrated in FIG. 2A.

It is to be noted that assuming that n1 is a refraction factor of the light guide plate 3 and n0 (<n1) is a refraction factor of a medium (an air layer) which is present outside the light guide plate 3, the critical angle α is expressed by the following equation. It is assumed that α and θ1 are the angles relative to the normal line of the light guide plate surface. Then, the angle of incidence θ1 that meets the conditions for total reflection is θ1>α.

Sin α=n0/n1

The scattering area 31 scatters and reflects the first illumination light L1 from the first light source 2 and makes at least part of the first illumination light L1 exit toward the first internally reflecting surface 3A as light rays (scattering light rays L20) that have failed to meet the conditions for total reflection as illustrated in FIG. 1.

The plurality of light shielding parts 41 are arranged between the light guide plate 3 and the second light source 7. The light shielding part 41 is arranged on a surface (the second internally reflecting surface 3B) of the light guide plate 3 which is in opposition to the second light source 7. The light shielding part 41 partially blocks the second illumination light L10 in order to improve the luminance distribution of the second illumination light L10. The scattering area 31 provided in the light guide plate 3 is adapted to scatter and reflect the light (the first illumination light L1) which is guided within the light guide plate 3 so as to take it out to the outside of the light guide plate 3. On the other hand, it is preferable that the light shielding part 41 be made of a regularly reflective (a mirror-reflective) material with which scattering action would not work on the first illumination light L1. For example, silver, aluminum, and the like may be used as a material which is high in reflectance and regularly reflects light. It is permissible, even if the material of the light shielding part 41 is not high in reflectance and is light-absorptive. However, in the above mentioned case, since the first illumination light L1 is absorbed, the luminance in three-dimensional display may be generally reduced and the light may be dimmed.

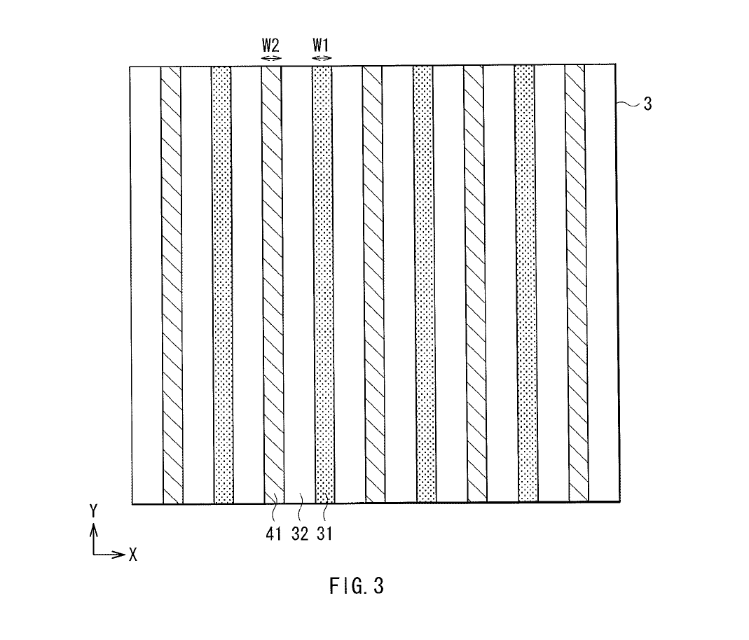

FIG. 3 illustrates one example of an arrangement pattern of the scattering areas 31 and the light shielding parts 41. The light shielding parts 41 are arranged at horizontal positions different from those of the scattering areas 31. The light shielding parts 41 are arranged at positions corresponding to spaces between the two adjacent scattering areas 31 one by one. The scattering areas 31 are arranged in a striped pattern in the example illustrated in FIG. 3. More specifically, the plurality of scattering areas 31 that vertically extend are horizontally arranged side-by-side at predetermined intervals. The light shielding parts 41 are also arranged in a striped pattern similarly to the scattering areas 31. A horizontal width W1 of the scattering area 31 and a horizontal width W2 of the light shielding part 41 are made almost the same as each other and the scattering areas 31 and the light shielding parts 41 are horizontally arranged almost at the same intervals in the example illustrated in FIG. 3.

It is to be noted that it is desirable that a pixel section of the display section 1 and the scattering areas 31 of the light guide plate 3 be arranged in opposition to each other by maintaining a predetermined distance for space division of the plurality of perspective images which are displayed on the display section 1 in the display device illustrated in FIG. 1. An air space is left between the display section 1 and the light guide plate 3 in the example in FIG. 1. Alternatively, a spacer may be arranged between the display section 1 and the light guide plate 3 in order to maintain the predetermined distance. In the above mentioned case, the spacer may be a transparent material which is reduced in light scattering properties and, for example, PMMA (poly (methyl methacrylate)) or the like may be used. The spacer may be disposed so as to entirely cover a surface on the rear surface side of the display section 1 and the surface of the light guide plate 3, or may be disposed as partially as possible in order to maintain the predetermined distance between them. Alternatively, the thickness of the light guide plate 3 may be generally increased to eliminate the air space.

### [Specific but not Limitative Configuration Examples of Scattering Area 31]

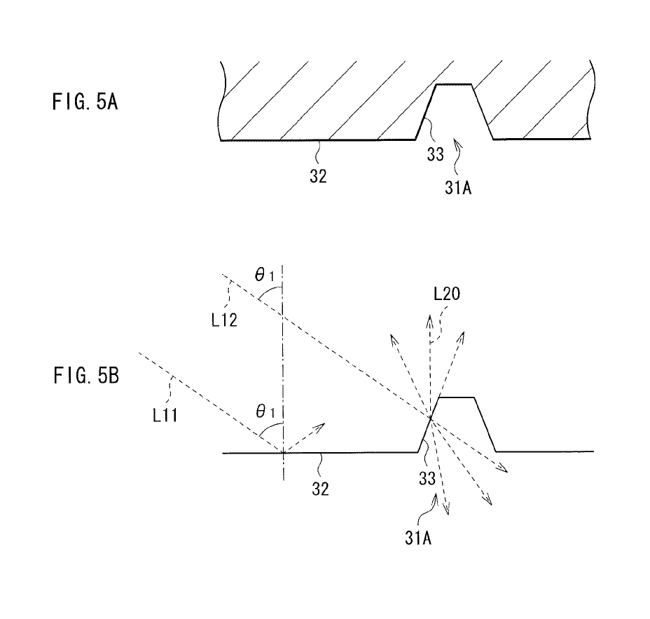

FIG. 5A illustrates a first configuration example of the second internally reflecting surface 3B of the light guide plate 3. FIG. 5B schematically illustrates examples of reflected state and scattered state of light rays on the second internally reflecting surface 3B in the first configuration example illustrated in FIG. 5A. In the first configuration example, a recessed scattering area 31A is formed in the totally reflecting area 32 as the scattering area 31. The recessed scattering area 31A may be formed by, for example, sand blasting or laser beam machining For example, it may be formed by performing laser beam machining on a part corresponding to the scattering area 31A after the surface of the light guide plate 3 has been mirror-finished. In the first configuration example, first illumination light L11 which has been incident at the angle of incidence θ1 that meets the conditions for total reflection from the first light source 2 is totally internally reflected from the totally reflecting area 32 on the second internally reflecting surface 3B. On the other hand, in the recessed scattering area 31A, some of light rays of incident first illumination light L12 fail to meet the conditions for total reflection on a side surface part 33 in the recessed area even when the light has been incident upon the area 31A at the same angle of incidence θ1 as that upon the totally reflecting area 32. Therefore, some light rays are scattered and transmitted through it and other light rays are scattered and reflected. Some of or all of the scattered and reflected light rays (the scattered light rays L20) exit toward the first internally reflecting surface 3A as light rays that have failed to meet the conditions for total reflection as illustrated in FIG. 1.

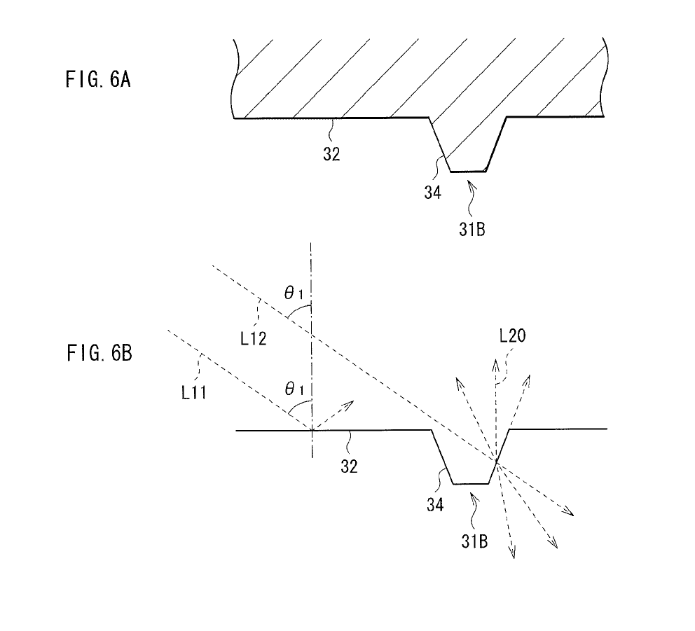

FIG. 6A illustrates a second configuration example of the internally reflecting surface 3B of the light guide plate 3. FIG. 6B schematically illustrates examples of reflected state and scattered state of light rays on the second internally reflecting surface 3B in the second configuration example illustrated in FIG. 6A. In the second configuration example, a protruded scattering area 31B is formed on the totally reflecting area 32 as the scattering area 31. The protruded scattering area 31B may be formed, for example, by molding the surface of the light guide plate 3 with a die. In the above mentioned case, a part corresponding to the totally reflecting area 32 is minor-finished using the surface of the die. In the second configuration example, the first illumination light L11 which has been incident at the angle of incidence θ1 that meets the conditions for total reflection from the first light source 2 is totally internally reflected from the totally reflecting area 32 on the second internally reflecting surface 3B. On the other hand, on the protruded scattering area 31B, some of light rays of the incident first illumination light L12 fail to meet the conditions for total reflection on a side surface part 34 on the protruded area 31B even when the light has been incident upon the area 31B at the same angle of incidence θ1 as that upon the totally reflecting area 32. Therefore, some light rays are scattered and transmitted through it and other light rays are scattered and reflected. Some of or all of the scattered and reflected light rays (the scattered light rays L20) exit toward the first internally reflecting surface 3A as light rays that have failed to meet the conditions for total reflection as illustrated in FIG. 1.

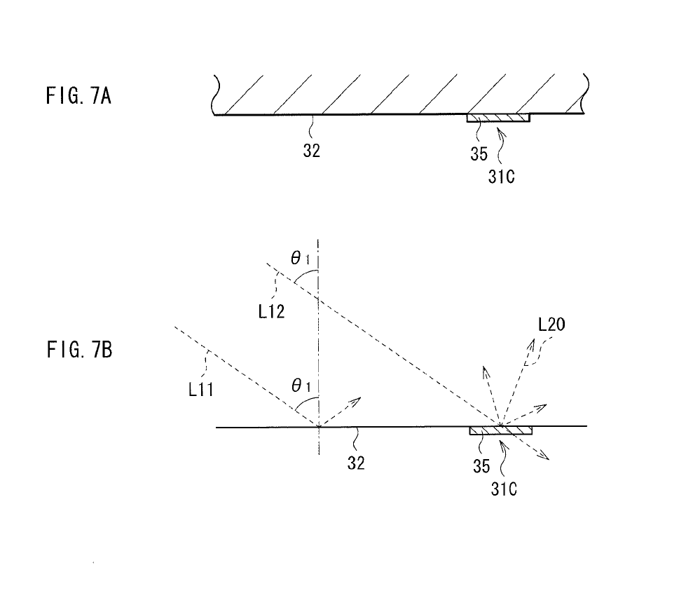

FIG. 7A illustrates a third configuration example of the second internally reflecting surface 3B of the light guide plate 3. FIG. 7B schematically illustrates examples of reflected state and scattered state of light rays on the second internally reflecting surface 3B in the third configuration example illustrated in FIG. 7A. In the configuration examples illustrated in FIG. 5A and FIG. 6A, the scattering area 31 is formed by surface-finishing the surface of the light guide plate 3 so as to have a shape which is different from that of the totally reflecting area 32. On the other hand, a scattering area 31C in the configuration example illustrated in FIG. 7A is formed not by surface-finishing but by arranging a light scattering member 35 which is made of a material different from that of the light guide plate 3 on a part of a surface of the light guide plate 3 corresponding to the second internally reflecting surface 3B. In the above mentioned case, the scattering area 31C may be formed by patterning the light scattering member 35 on the surface of the light guide plate 3 by screen printing using, for example, a white coating material (for example, barium sulfate). In the third configuration example, the first illumination light L11 which has been incident at the angle of incidence θ1 that meets the conditions for total reflection from the first light source 2 is totally internally reflected from the totally reflecting area 32 on the second internally reflecting surface 3B. On the other hand, on the scattering area 31C on which the light scattering member 35 is arranged, some light rays of the incident first illumination light L12 are scattered and transmitted through the light scattering member 35 and other light rays are scattered and reflected even when it has been incident upon the area 31C at the same angle of incidence θ1 as that upon the totally reflecting area 32. Therefore, some of or all of the scattered and reflected light rays exit toward the first internally reflecting surface 3A as light rays that have failed to meet the conditions for total reflection.

### [Basic Operations of Display Device]

When display in the three-dimensional display mode is to be performed by the display device so configured as mentioned above, an image which is based on the three-dimensional image data is displayed on the display section 1, and the first light source 2 and the second light source 7 are ON (turned-on)/OFF (not turned-on) controlled so as to cope with the three-dimensional display. Specifically, the first light source 2 is controlled to enter the ON (turned-on) state and the second light source 7 is controlled to enter the OFF (not turned-on) state as illustrated in FIG. 1. In the above mentioned state, the first illumination light L1 from the first light source 2 is totally internally reflected again and again between the first internally reflecting surface 3A and the totally reflecting area 32 of the second internally reflecting surface 3B in the light guide plate 3, by which it is guided from one side surface on the side where the first light source 2 is arranged to the opposing other side surface and exits from the other side surface. On the other hand, part of the first illumination light L1 from the first light source 2 is scattered and reflected by the scattering area 31 of the light guide plate 3, by which it is transmitted through the first internally reflecting surface 3A of the light guide plate 3 and exits outside of the light guide plate 3. Thus, it is allowed to let the light guide plate itself have the function as the parallax barrier. That is, it is allowed to make the light guide plate 3 equivalently function as the parallax barrier such that the scattering area 31 functions as the opening (the slit part) and the totally reflecting area 32 functions as the shielding part for the first illumination light L1 from the first light source 2. Thus, it is allowed to equivalently perform three-dimensional display by the parallax barrier system in which the parallax barrier is arranged on the rear surface side of the display section 1.

It is to be noted that the light shielding part 41 functions in the same manner as the totally reflecting area 32 for the first illumination light L1 by forming it using, for example, the regularly reflective (mirror-reflective) material with which the scattering action would not work on the first illumination light L1. Therefore, since the angle of the light which is guided in the light guide plate 3 does not change even when it is incident upon the light shielding part 41, it is continuously guided within the guide light plate 3 as it is and will not exit outside from the first internally reflecting surface 3A.

On the other hand, when display in the two-dimensional display mode is to be performed, an image which is based on the two-dimensional image data is displayed on the display section 1, and the first light source 2 and the second light source 7 are ON (turned-on)/OFF (not turned-on) controlled so as to cope with the two-dimensional display. Specifically, the first light source 2 is controlled to enter the OFF (not turned-on) state and the second light source 7 is controlled to enter the ON (turned-on) state, for example, as illustrated in FIG. 2A. In the above mentioned case, the second illumination light L10 from the second light source 7 is transmitted through the totally reflecting area 32 of the second internally reflecting surface 3B, by which it exits outside of the light guide plate 3 from the almost entire surface of the first internally reflecting surface 3A as light rays that have failed to meet the conditions for total reflection. That is, the light guide plate 3 functions as a surface light source which is the same as a general backlight. Thus, two-dimensional display which is based on the backlight system in which the general backlight is arranged on the rear surface side of the display section 1 is equivalently performed.

It is to be noted that although the second illumination light L10 exits from almost the entire surface of the light guide plate 3 even when only the second light source 7 has been turned on, the first light source 2 may be also turned on as the case may be. Thus, for example, when a difference in luminance distribution occurs between parts corresponding to the scattering area 31 and the totally reflecting area 32 simply by turning only the second light source 7 on, it is allowed to optimize the luminance distribution over the entire surface by appropriately adjusting (ON/OFF controlling or adjusting the lighting amount) the turned-on state of the first light source 2. However, for example, when sufficient correction for the luminance is ensured on the display section 1 side for two-dimensional display, only the second light source 7 may be turned on.

### [Operational Effects by Provision of Light Shielding Part 41]

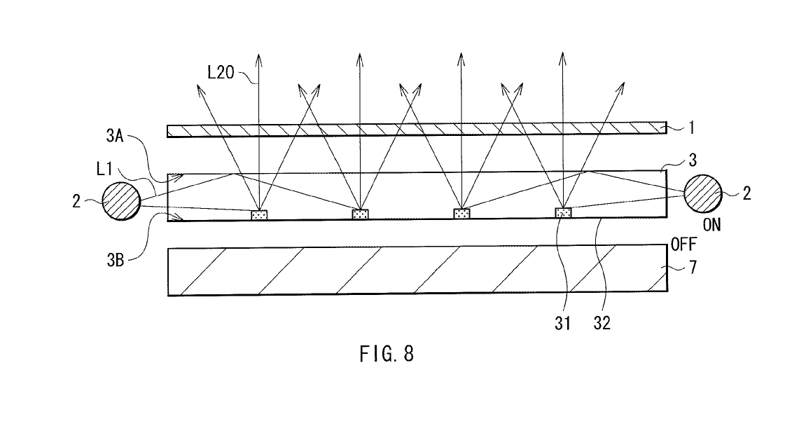

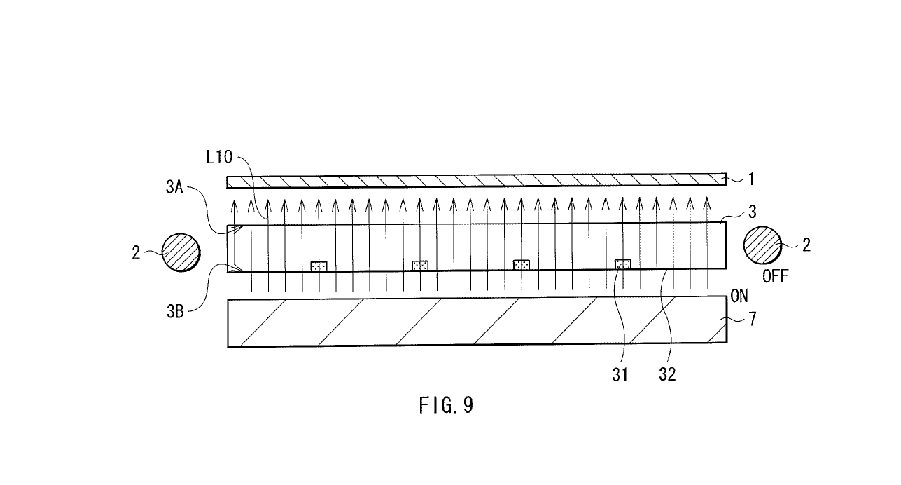

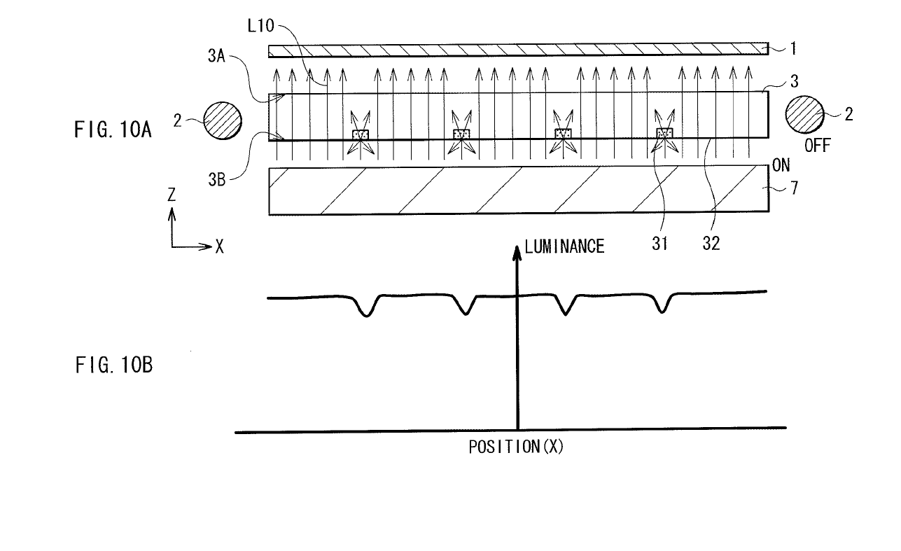

Next, operational effects brought about by provision of the light shielding part 41 will be described. First, disadvantages observed when the light shielding part 41 is not disposed on the configuration illustrated in FIG. 1 will be described as a comparative example, for example, as illustrated in FIG. 8. FIG. 8 illustrates an example of a light ray exiting state when only the first light source 2 has been set to the ON (turned-on) state (in the three-dimensional display mode) in a display device according to the comparative example. On the other hand, FIG. 9 illustrates an example of an ideal light ray exiting state when only the second light source 7 has been set to the ON (turned-on) state (in the two-dimensional display mode) in the display device according to the comparative example. When only the second light source 7 has been set to the ON (turned-on) state, it is ideal that the second illumination light L10 be equally transmitted through the totally reflecting area 32 and the scattering area 31 in the light guide plate 3 and exit outside uniformly from the almost entire surface of the first internally reflecting surface 3A as illustrated in FIG. 9. However, scatter transmission and scatter reflection of the second illumination light L10 occur in the scattering area 31 in reality. Thus, a direction in which a light ray exits is changed at a position corresponding to the scattering area 31, by which the luminance of the light ray that exits outside of the light guide plate 3 is reduced to make the luminance distribution non-uniform as compared with the totally reflecting area 32. FIG. 10A illustrates an example of a light ray exiting state in the two-dimensional display mode when scatter transmission and scatter reflection which would occur in the scattering area 31 as described above are taken into consideration. FIG. 10B illustrates an example of an X-directional luminance distribution in the light ray exiting state illustrated in FIG. 10A.

In the comparative example, the luminance is reduced at the position corresponding to the scattering area 31 as illustrated in FIG. 10B. In particular, when it is tried to increase the number of perspective for three-dimensional display, a space with which the scattering areas 31 are horizontally arranged will be increased to increase a positional interval at which the scattering areas 31 are horizontally arranged. In the above mentioned case, a cycle in which a luminance reduction occurs will be increased and the luminance reduction will be liable to be visually observed.

FIG. 2B illustrates an example of an X-directional luminance distribution in the two-dimensional display mode obtained when the light shielding part 41 is disposed in contrast to the above mentioned comparative example. The luminance reduction occurs on parts corresponding to the scattering area 31 and the light shielding part 41 for the second illumination light L10 from the second light source 7 as illustrated in FIG. 2B. However, the cycle in which the luminance reduction occurs is reduced owing to provision of the light shielding part 41 as compared with the comparative example illustrated in FIG. 10A and FIG. 10B. The scattering areas 31 and the light shielding parts 41 are alternately arranged horizontally at almost the same intervals, by which the cycle in which the luminance reduction occurs is almost halved as compared with the comparative example. Thus, it becomes difficult to visually observe the luminance reduction. It is preferable to appropriately adjust the horizontal width W2 (see FIG. 3) of the light shielding part 41 depending on the degree of luminance reduction occurring in the scattering area 31.

### [Effects]

As described above, according to the display device of the first embodiment, since the scattering area 31 and the totally reflecting area 32 are disposed in and/or on the second internally reflecting surface 3B of the light guide plate 3 such that the first illumination light L1 from the first light source 2 and the second illumination light L10 from the second light source 7 selectively exit outside of the light guide plate 3, it is allowed to make the light guide plate 3 itself equivalently function as the parallax barrier. Thus, it is allowed to reduce the number of components as compared with an existing stereoscopic display device of the parallax barrier system to promote space saving.

In addition, according to the display device of the first embodiment, the light shielding part 41 is disposed at the horizontal position different from that of the scattering area 31 between the light guide plate 3 and the second light source 7, i.e., the light shielding parts 41 are arranged between the light guide plate 3 and the second light source 7 at the positions other than the positions corresponding to the plurality of scattering areas 31. Hence, it is allowed to improve the luminance distribution when the second illumination light L10 has been emitted. Thus, it is allowed to obtain illumination light which is appropriately distributed in luminance. In particular, it is allowed to improve the luminance distribution in two-dimensional display.

### 2. Second Embodiment

Next, a display device according to a second embodiment of the present disclosure will be described. It is to be noted that the same numerals are assigned to constitutional components which are substantially the same as those in the display device according to the first embodiment and description thereof will be appropriately omitted.

As the second embodiment, a plurality of modification examples of the display device according to the first embodiment will be described.

### FIRST MODIFICATION EXAMPLE

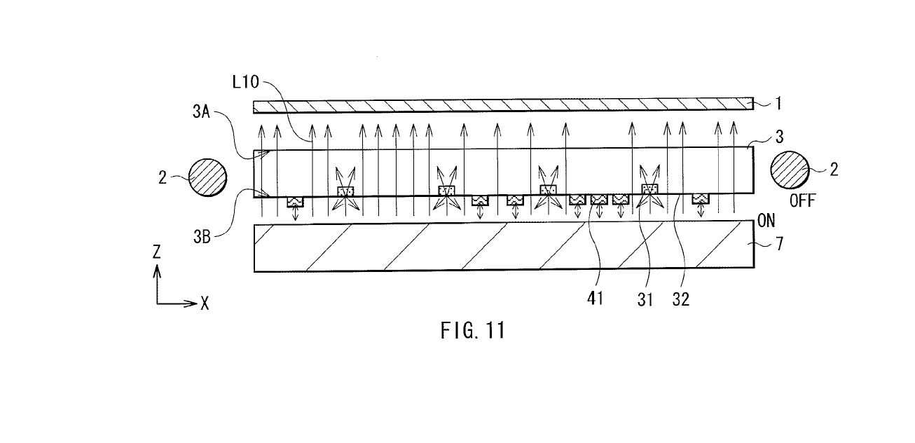

FIG. 11 illustrates one configuration example of a display device according to a first modification example, together with an example of a light ray exiting state observed when only the second light source 7 has been set to the ON (turned-on) state. In the configuration example illustrated in FIG. 1 to FIG. 3, the cycle in which the illumination reduction occurs is about halved by alternately arranging the scattering areas 31 and the light shielding parts 41 horizontally at almost the same intervals, as compared with the case that the light shielding part 41 is not disposed. However, the cycle in which the luminance reduction occurs may be made less than half the cycle obtained when the light shielding part 41 is not disposed. In the above mentioned case, the arrangement number of the light shielding parts 41 in the horizontal direction may be made larger than that of the scattering areas 31. In addition, although the light shielding parts 41 are uniformly arranged at the positions corresponding to the spaces between the two adjacent scattering areas 31 one by one in the configuration example illustrated in FIG. 1 to FIG. 3, the light shielding parts 41 may not necessarily be arranged uniformly. FIG. 11 illustrates an example in which the number of the light shielding parts 41 to be arranged at the positions corresponding to the spaces between the two adjacent scattering areas 31 is changed depending on horizontal positions.

### SECOND MODIFICATION EXAMPLE

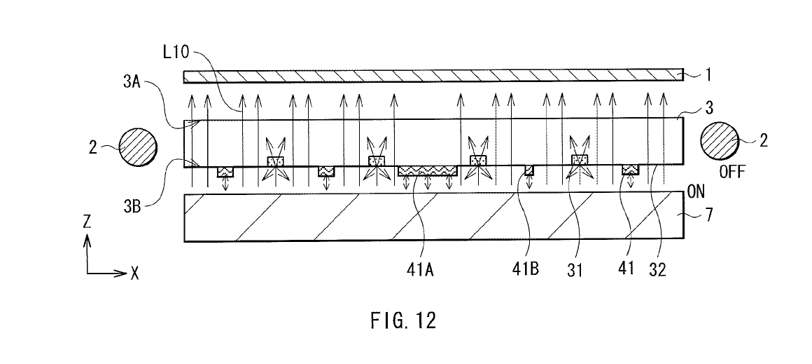

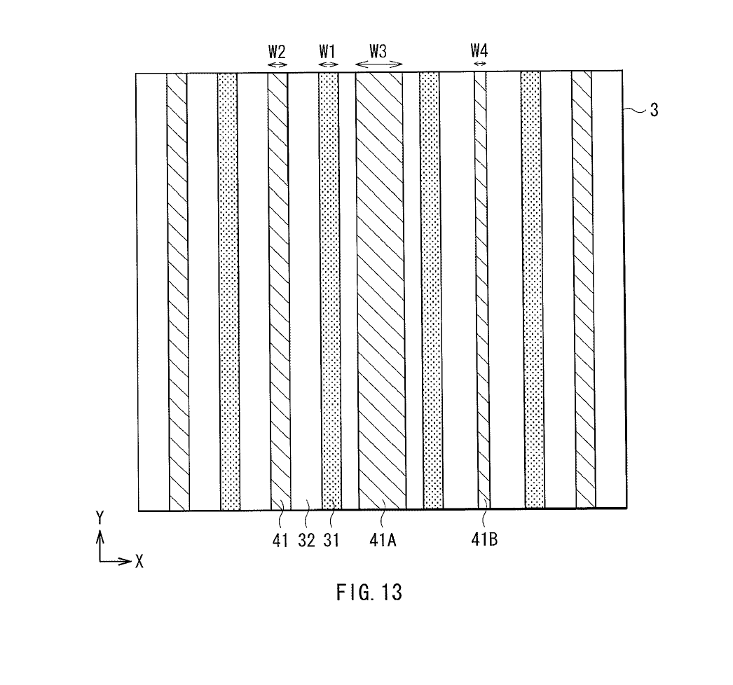

FIG. 12 illustrates one configuration example of a display device according to a second modification example, together with an example of a light ray exiting state observed when only the second light source 7 has been set to the ON (turned-on) state. FIG. 13 illustrates one example of the arrangement pattern of the scattering areas 31 and the light shielding parts 41 in the display device according to the second modification example. Although the horizontal width W1 of the scattering area 31 is made almost the same as the horizontal width W2 of the light shielding part 41 in the configuration example illustrated in FIG. 1 to FIG. 3, the horizontal width W2 of the light shielding part 41 may be different from the width W1 depending on places. For example, a light shielding part 41A of a width W3 which is wider than the horizontal width W1 of the scattering area 31 and a light shielding part 41B of a width W4 which is narrower than the width W1 may be arranged in a mixed state, for example, as illustrated in FIG. 13.

### THIRD MODIFICATION EXAMPLE

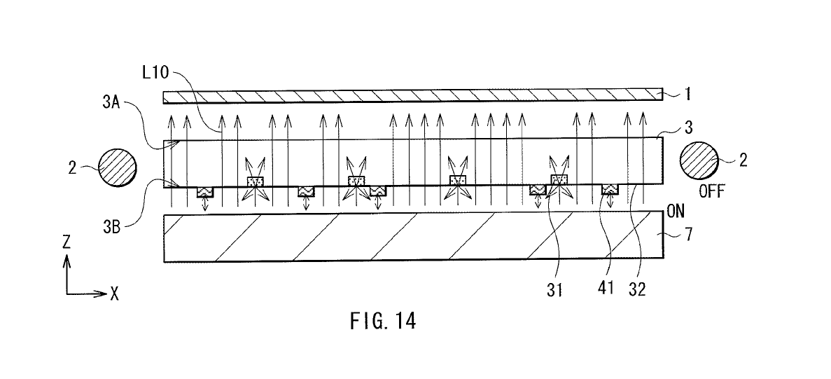

FIG. 14 illustrates one configuration example of a display device according to a third modification example, together with an example of a light ray exiting state observed when only the second light source 7 has been set to the ON (turned-on) state. Although the plurality of light shielding parts 41 are uniformly arranged side-by-side in the horizontal direction at the predetermined interval in the configuration example illustrated in FIG. 1 to FIG. 3, a horizontal arrangement pitch of the light shielding parts 41 may be changed depending on places as illustrated in FIG. 14. In addition, the light shielding part 41 may not necessarily be arranged at the center between the two adjacent scattering areas 31.

### FOURTH MODIFICATION EXAMPLE

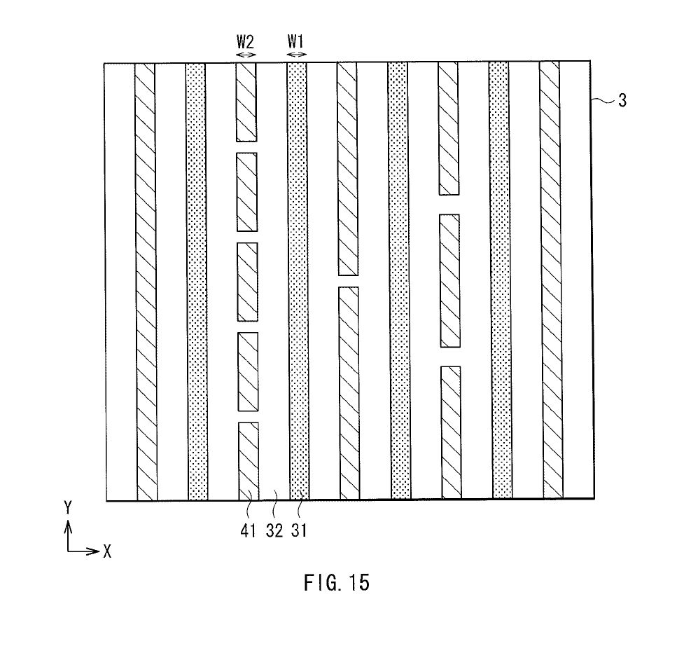

FIG. 15 illustrates one example of the arrangement pattern of the scattering areas 31 and the light shielding parts 41 in a display device according to a fourth modification example. Although both the scattering areas 31 and the light shielding parts 41 are arranged in vertically-and-continuously-extending striped patterns in the configuration example illustrated in FIG. 3, the vertical patterns are not limited to the above. That is, the vertical patterns of the scattering areas 31 and the light shielding parts 41 may be different from each other. For example, the scattering areas 31 may have a striped pattern in which all the areas 31 continuously extend in the vertical direction, and the light shielding parts 41 may have a striped pattern in which the lengths thereof are partially different from one another depending on places.

### FIFTH MODIFICATION EXAMPLE

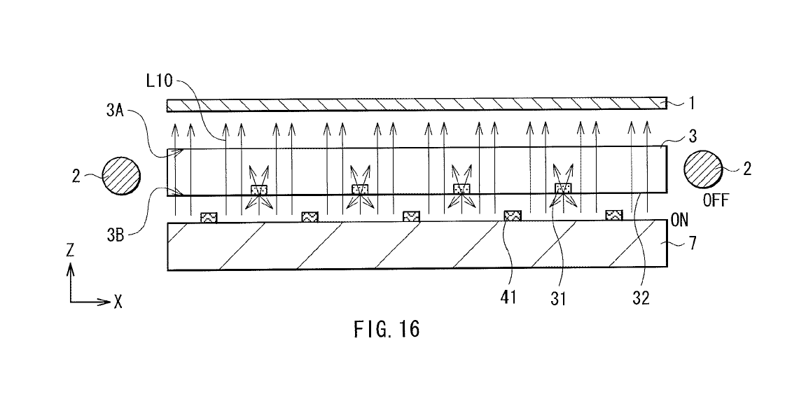

FIG. 16 illustrates one configuration example of a display device according to a fifth modification example, together with an example of a light ray exiting state observed when only the second light source 7 has been set to the ON (turned-on) state. Although the light shielding parts 41 are arranged on the surface (the second internally reflecting surface 3B) opposed to the second light source 7 on the light guide plate 3 in the configuration example illustrated in FIG. 1, the arrangement position of each light shielding part 41 is not limited to the above. Alternatively, the light shielding parts 41 may be arranged on a surface of the second light source 7 which is opposed to the light guide plate 3, for example, as illustrated in FIG. 16.

### SIXTH MODIFICATION EXAMPLE

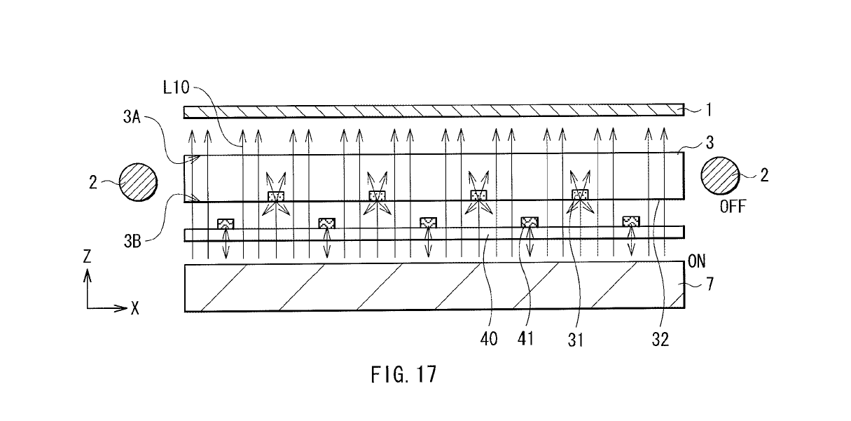

FIG. 17 illustrates one configuration example of a display device according to a sixth modification example, together with an example of a light ray exiting state observed when only the second light source 7 has been set to the ON (turned-on) state. Although the light shielding parts 41 are arranged on one surface of the light guide plate 3 or the second light source 7 in the configuration example illustrated in FIG. 1 or FIG. 16, the light shielding parts 41 may be arranged on a member other than the light guide plate 3 and the second light source 7. For example, a transparent plate 40 such as, for example, a glass substrate may be arranged between the light guide plate 3 and the second light source 7, and the light shielding parts 41 may be arranged on the transparent plate 40, for example, as illustrated in FIG. 17.

### SEVENTH MODIFICATION EXAMPLE

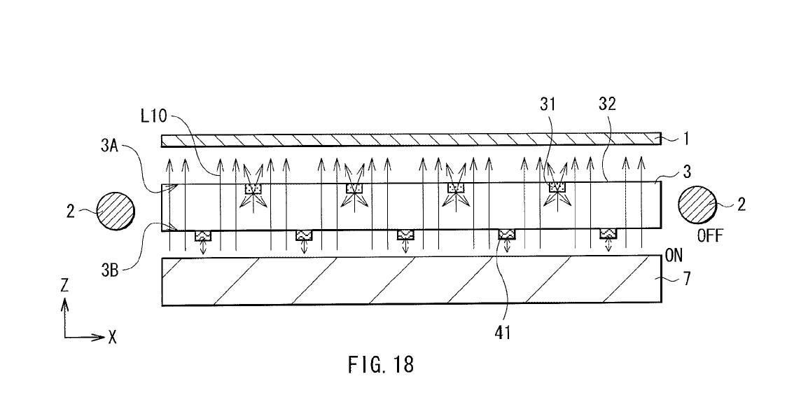

FIG. 18 illustrates one configuration example of a display device according to a seventh modification example, together with an example of a light ray exiting state observed when only the second light source 7 has been set to the ON (turned-on) state. Although the configuration example in which the scattering areas 31 and the totally reflecting areas 32 are disposed on the second internally reflecting surface 3B side of the light guide plate 3 has been described in the first embodiment, a configuration in which the scattering areas 31 and the totally reflecting areas 32 are disposed on the internally reflecting surface 3A side, for example, as illustrated in FIG. 18 may be adopted. In the above mentioned case, the second internally reflecting surface 3B is mirror-finished over the entire surface.

In addition, a configuration in which the above mentioned modification examples are combined with one another in any combination is permissible. For example, the first modification example may be combined with the second modification example such that the number of the light shielding parts 41 which are horizontally arranged is made larger than that of the scattering areas 31, and the horizontal widths W2 of the respective light shielding parts 41 are made different from one another depending on places. In addition, the materials (the reflectances) of the respective light shielding parts 41 may be made different from one another depending on places.

### 3. Other Embodiments

The technology according to the present disclosure may be modified in a variety of ways without limited to description of the above mentioned embodiments.

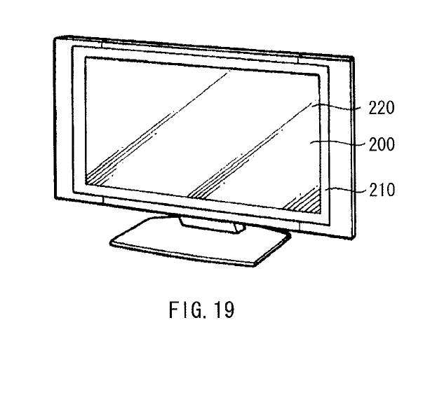

For example, the display devices according to the above-mentioned respective embodiments may be applied to various types of electronic apparatuses having the displaying function. FIG. 19 illustrates one appearance configuration example of a TV set as one example of such electronic apparatus as mentioned above. This TV set includes an image display screen section 200 that includes a front panel 210 and a filter glass sheet 220.

Accordingly, it is possible to achieve at least the following configurations from the above-described example embodiments and the modifications of the disclosure.
(1) A display device, including:

a display section displaying an image; and

a light source unit emitting light for image display toward the display section, wherein the light source unit includes

a first light source emitting first illumination light,

a light guide plate including a plurality of scattering areas each allowing the first illumination light that has entered the light guide plate through a side surface thereof to be scattered and to exit therethrough,

a second light source disposed to face the light guide plate, and emitting second illumination light toward the light guide plate from a direction different from a light emitting direction of the first light source, and

light shields arranged between the light guide plate and the second light source at positions other than positions corresponding to the plurality of scattering areas, each of the light shields blocking the second illumination light.
(2) The display device according to (1), wherein at least one light shield is disposed at a position corresponding to a position between two adjacent scattering areas.
(3) The display device according to (1) or (2), wherein the light shields are arranged on a surface of the light guide plate, the surface facing the second light source.
(4) The display device according to (1) or (2), wherein the light shields are arranged on a surface of the second light source, the surface facing the light guide plate.
(5) The display device according to (1) or (2), further including a transparent plate arranged between the light guide plate and the second light source,

wherein the light shields are arranged on the transparent plate.
(6) The display device according to any one of (1) to (5), wherein

the display section selectively switches images to be displayed between perspective images based on three-dimensional image data and an image based on two-dimensional image data, and

the second light source is controlled to be turned off when the perspective images are to be displayed on the display section, and is controlled to be turned on when the image based on the two-dimensional image data is to be displayed on the display section.
(7) The display device according to (6), wherein the first light source is controlled to be turned on when the perspective images are to be displayed on the display section, and is controlled to be either turned off or turned on when the image based on the two-dimensional image data is to be displayed on the display section.
(8) A light source device, including:

a first light source emitting first illumination light;

a light guide plate including a plurality of scattering areas each allowing the first illumination light that has entered the light guide plate through a side surface thereof to be scattered and to exit therethrough;

a second light source disposed to face the light guide plate, and emitting second illumination light toward the light guide plate from a direction different from a light emitting direction of the first light source; and

light shields arranged between the light guide plate and the second light source at positions other than positions corresponding to the plurality of scattering areas, each of the light shields blocking the second illumination light.
(9) An electronic apparatus with a display device, the display device including:

a display section displaying an image; and

a light source unit emitting light for image display toward the display section, wherein the light source unit includes

a first light source emitting first illumination light,

a light guide plate including a plurality of scattering areas each allowing the first illumination light that has entered the light guide plate through a side surface thereof to be scattered and to exit therethrough,

a second light source disposed to face the light guide plate, and emitting second illumination light toward the light guide plate from a direction different from a light emitting direction of the first light source, and

light shields arranged between the light guide plate and the second light source at positions other than positions corresponding to the plurality of scattering areas, each of the light shields blocking the second illumination light.

It is to be noted that any combinations of (2) to (7) directed to the display device are applicable to each of (8) directed to the light source device and (9) directed to the electronic apparatus unless any contradictions occur. Such combinations are also considered as preferred combinations of embodiments according to the technology.

The disclosure contains subject matter related to that disclosed in Japanese Priority Patent Application JP 2011-246773 filed in the Japan Patent Office on Nov. 10, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a display section displaying an image; and
a light source unit emitting light for image display toward the display section, wherein the light source unit includes
a first light source emitting first illumination light,
a light guide plate including a plurality of scattering areas each allowing the first illumination light that has entered the light guide plate through a side surface thereof to be scattered and to exit therethrough,
a second light source disposed to face the light guide plate, and emitting second illumination light toward the light guide plate from a direction different from a light emitting direction of the first light source, and
light shields arranged between the light guide plate and the second light source at positions other than positions corresponding to the plurality of scattering areas, each of the light shields blocking the second illumination light.

2. The display device according to claim 1, wherein at least one light shield is disposed at a position corresponding to a position between two adjacent scattering areas.

3. The display device according to claim 1, wherein the light shields are arranged on a surface of the light guide plate, the surface facing the second light source.

4. The display device according to claim 1, wherein the light shields are arranged on a surface of the second light source, the surface facing the light guide plate.

5. The display device according to claim 1, further comprising a transparent plate arranged between the light guide plate and the second light source,
wherein the light shields are arranged on the transparent plate.

6. The display device according to claim 1, wherein
the display section selectively switches images to be displayed between perspective images based on three-dimensional image data and an image based on two-dimensional image data, and
the second light source is controlled to be turned off when the perspective images are to be displayed on the display section, and is controlled to be turned on when the image based on the two-dimensional image data is to be displayed on the display section.

7. The display device according to claim 6, wherein the first light source is controlled to be turned on when the perspective images are to be displayed on the display section, and is controlled to be either turned off or turned on when the image based on the two-dimensional image data is to be displayed on the display section.

8. A light source device, comprising:
a first light source emitting first illumination light;
a light guide plate including a plurality of scattering areas each allowing the first illumination light that has entered the light guide plate through a side surface thereof to be scattered and to exit therethrough;
a second light source disposed to face the light guide plate, and emitting second illumination light toward the light guide plate from a direction different from a light emitting direction of the first light source; and
light shields arranged between the light guide plate and the second light source at positions other than positions corresponding to the plurality of scattering areas, each of the light shields blocking the second illumination light.

9. An electronic apparatus with a display device, the display device comprising:
a display section displaying an image; and
a light source unit emitting light for image display toward the display section, wherein the light source unit includes
a first light source emitting first illumination light,
a light guide plate including a plurality of scattering areas each allowing the first illumination light that has entered the light guide plate through a side surface thereof to be scattered and to exit therethrough,
a second light source disposed to face the light guide plate, and emitting second illumination light toward the light guide plate from a direction different from a light emitting direction of the first light source, and
light shields arranged between the light guide plate and the second light source at positions other than positions corresponding to the plurality of scattering areas, each of the light shields blocking the second illumination light.
